(19) United States
(12) Patent Application Publication
(10) Pub. No.: US 2005/0174943 A1
(43) Pub. Date: Aug. 11, 2005

(54) End-to-end mapping of VLAN ID and 802.1P COS to multiple BSSID for wired and wireless LAN

(76) Inventor: Shiwei Wang, Taipei (TW)

Correspondence Address: J.C. Patents, Suite 250, 4 Venture, Irvine, CA, 92618, US

(21) Appl. No.: 11/103,021

(22) Filed: Apr. 11, 2005

Related U.S. Application Data
(63) Continuation-in-part of application No. 10/938,379, filed on Sep. 10, 2004.
(60) Provisional application No. 60/481,351, filed on Sep. 10, 2003.

(51) Int. Cl. H04L 12/26; H04L 12/28; H04L 12/56

(52) U.S. Cl. 370/235; 370/395.21

(57) ABSTRACT

A quality of service (QoS) based load-balancing scheme in network communication between a local area network (LAN) and a wireless local area network (WLAN) is provided. The load balancing decision is made by a load balancing module according to traffic conditions and bandwidth availability of each traffic priority class based on a corresponding class of service. The load balancing module also maps an identifier in the LAN to one or more identifiers (BSSIDs or SSIDs) in the WLAN for accommodating the communication between LAN and WLAN for maintaining the quality of service (QoS). The identifier in the LAN can be a VLAN tag at the LAN, or identity of the port, physical address of terminals including MAC address, Token Ring or etc. protocols, or Internet address (IP) according to LAN standards.

### CROSS-REFERENCE TO RELATED APPLICATION

This application is a continuation-in-part of application Ser. No. 10/938,379, filed on Sep. 10, 2004, now pending, which claims the priority benefits of U.S. provisional application Ser. No. 60/481,351, filed on Sep. 10, 2003. All disclosures are incorporated herewith by reference.

### BACKGROUND OF THE INVENTION

1. Field of the Invention

This invention relates to balancing traffic loads and improving throughput in network communication, and more particularly to a QoS (quality of service) based load-balancing scheme in network communication between a local area network (LAN) and a wireless local area network (WLAN).

2. Description of Related Art

A network of communication links may be split into sub-networks. A physical sub-network is sometimes separated from other physical sub-networks for security reasons. Each sub-network includes a number of bridges and a number of links, such as Ethernet links. Each bridge has a port for each link. Each bridge is arranged to forward data packets which are received by a port of the bridge either via another port of the bridge to another bridge of the sub-network or directly to a device with a destination address which is usually connected to one of the bridges. The data packets include information related to the destination address, allowing for the correct forwarding of a data packet by a bridge.

Adjacent sub-networks may share a multi-bridge capable of forwarding data packets to ports for both sub-networks. The multi-bridge includes several ports. To allow for optimal use of the bandwidth available on a sub-network, a number of mutually different and logically segregated Virtual Local Area Networks (VLANs) can be used. In a situation where a sub-network can be used by a number of mutually different VLANs, data packets include information that identifies the VLAN over which the data packet is sent. This information is usually referred to as an identifier (VLAN ID). The multi-bridge is capable of extracting the VLAN ID from a data packet. This will enable the multi-bridge to forward a data packet not only via the correct port, but also via the correct VLAN.

There are three prior art methods of defining the correct VLAN to which a data packet belongs: (1) a method based on the identity of the port that receives the frame; (2) a method based on the physical address of the terminal that sent the frame (medium access control address of the Ethernet, Token Ring, etc. protocol); (3) a method based on Internet address (IP), which each data packet contains and constitutes the logical address of the terminal that sent the data packet. Using the above three methods, the virtual network to which the data packet belongs can be determined on the basis of logical rules, that is to say by reading a label inserted into the data packet and containing an explicit virtual network identifier.

The IEEE (Institute of Electrical and Electronics Engineers) 802.3 standard defines a format with which these virtual networks cannot be distinguished explicitly. IEEE 802.1Q standard is an extension of the foregoing standard that defines a labeled data packet for distinguishing a plurality of virtual networks explicitly. In each data packet, a “length/type” field indicates if that frame is labeled or not. If it is labeled, a “label” field contains a twelve-bit number that identifies a virtual network explicitly. The 802.1Q standard prohibits a router or a switch from sending data packets of two types over the same network for the same virtual network. According to the standard, the ports of a router or of a switch can be configured individually so that they label the data packets belonging to a given virtual network. A router conforming to the IEEE 802.1Q standard can send on the same link data packets belonging to different virtual networks.

IEEE 802.1P standard is a part of the IEEE standard 802.1D. The IEEE 802.1P standard covers traffic class expediting and dynamic multicast filtering part of media access control (MAC) bridges, which is known as the IEEE standard 802.1D. In the developing Ethernet technology, the wireless local area network (WLAN) is used more and more popularly, not only the LAN technology. Due to rapidly increasing use Internet through for instance Public Switched Telecommunication Network (PSTN), it is forced to implement IP-based networks as their PSTN backbones. A network like this without any Quality of Service mechanisms would be disastrous. Just imagine yourself trying to get an emergency call through while others just surf the Internet.

According to the IEEE standard 802.1p, the Quality of Service has to consider a plurality of parameters, for example, service availability—service availability is measured as ratio between MAC services is unavailable and available. In order to increase service availability automatic reconfiguration of the Bridged Local Area Network ought to be adopted, or frame loss, frame missorder, frame duplication, the transit delay experienced by frames, frame lifetime, the undetected frame error rate, maximum service data unit size supported, user priority, or throughput, etc.

It is important to provide architecture for load-balancing scheme in network communication between a local area network (LAN) and a wireless local area network (WLAN), especially for providing a quality of service (QoS) based communication.

### SUMMARY OF THE INVENTION

Therefore, one object of this present invention is to provide a quality of service (QoS) based load-balancing scheme in network communication between a local area network (LAN) and a wireless local area network (WLAN).

In the quality of service (QoS) based load-balancing scheme in network communication between a local area network (LAN) and a wireless local area network (WLAN) is provided. The load balancing decision is made by a load balancing module according to traffic conditions and bandwidth availability of each traffic priority class based on a corresponding class of service. The load balancing module also maps an identifier in the LAN to one or more identifiers (BSSIDs or SSIDs) in the WLAN for accommodating the communication between LAN and WLAN for maintaining the quality of service (QoS). The identifier in the LAN can be a VLAN tag at the LAN, or identity of the port, physical address of terminals including MAC address, Token Ring or etc. protocols, or Internet address (IP) according to LAN standards.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF THE DRAWINGS

FIG. 1 is a schematic diagram illustrating the structures of an Ethernet data packet and a tag control information field thereof as defined under IEEE 802.1Q/p.

FIG. 2, a schematic overview of architecture of network communication including two wired sub-networks and a wireless network.

### DESCRIPTION OF THE PREFERRED EMBODIMENTS

In the invention, it provides architecture for quality of service (QoS) based load-balancing scheme in network communication between a local area network (LAN) and a wireless local area network (WLAN).

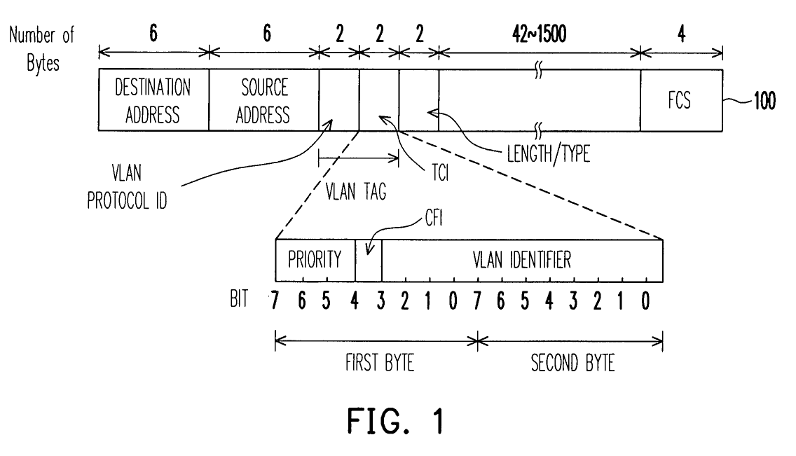

Referring to FIG. 1, which is a schematic diagram illustrating the structures of an Ethernet data packet and a tag control information field thereof as defined under IEEE 802.1Q/p. In FIG. 1, the Ethernet data packet includes a VLAN tag, in which a tag control information (TCI) field is included. In the TCI field, the most significant 3 bits of this field are used for representing a priority level (marked with “PRIORITY” in FIG. 1), thereby enabling the Ethernet data packet to have one of eight different levels of priorities. Each packet assigned with a priority as described above is generally forwarded through the network in accordance with PQ (Priority Queuing). Specifically, according to PQ, a number of queues corresponding to different levels of priority are provided in the switch. Each packet which arrives at the switch is stored in a queue corresponding to its priority level. Then, according to a predetermined timing, the switch selects the highest priority queue that includes a packet therein, and fetches the packet therefrom so as to be sent over the network. Furthermore, when traffic streams from a plurality of users are multiplexed to one link, an assured bandwidth which is available to each user is set. To ensure that the above-described assured bandwidth is actually available to each user, bandwidth control is required. In the TCI field, a VLAN identifier (VLAN ID) is also included in the 11 least significant bits. In the different VLANs, data packets include information that identifies the VLAN over which the data packet is sent. This information is usually referred to the VLAN ID.

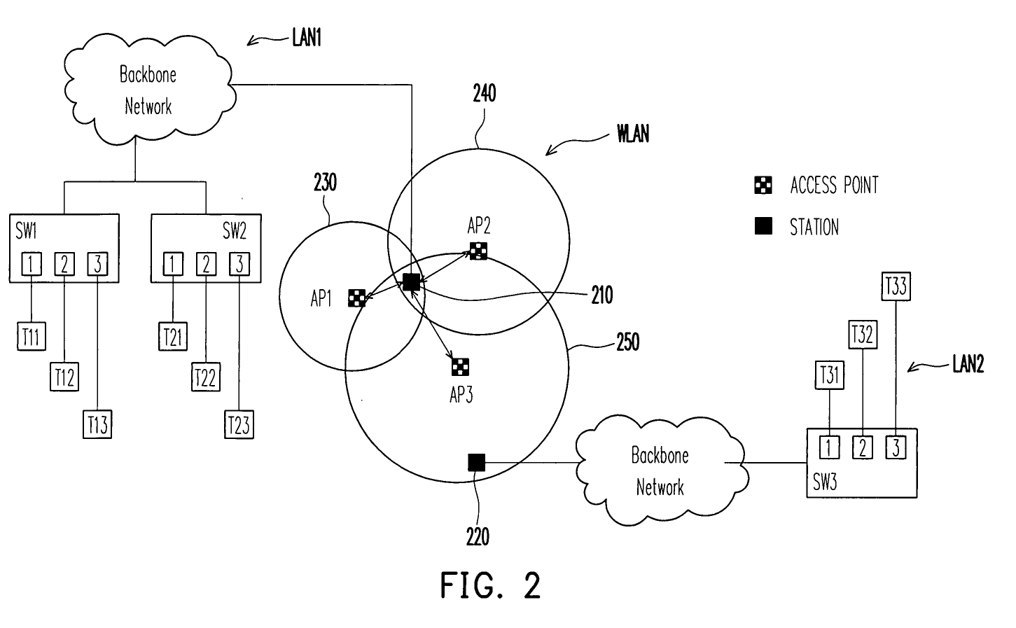

Referring to FIG. 2, a schematic overview of architecture of network communication including two wired sub-networks and a wireless network. In the architecture, wired local area network LAN1, LAN2 and a wireless local area network WLAN constitute the communication, for example. The LAN1 includes at least two switches SW1 and SW2, each of which includes three ports. These ports are respectively connected to three terminals T11, T12, T13 and T21, T22 and T23. Through a backbone network, the LAN1 connects to a network station 210 in the wireless local area network WLAN for wireless communication. The LAN2 includes one switch SW3, which includes three ports. These ports are respectively connected to three terminals T31, T32 and T33. Through a backbone network, the LAN2 connects to a network station 220 in the wireless local area network WLAN for wireless communication. As shown in FIG. 1, the wireless local area network WLAN includes at least three access points AP1, AP2 and AP3, each of which has its own coverage areas 230, 240 and 250.

The load-balancing scheme for the wireless local area network WLAN is proposed in the US Patent Application titled “QoS BASED LOAD-BALANCE POLICY FOR WLAN” filed on Sep. 10, 2004, Ser. No. 10/938,379, which is filed by the same applicant of the application, which is incorporated herewith by reference.

By incorporating the QoS based load-balance policy for WLAN as described in the inventor's prior application, the invention here provides architecture for quality of service (QoS) based load-balancing scheme in network communication between a local area network (LAN) and a wireless local area network (WLAN). For example, if data packets are sent from the terminals T11, T12, T13 T11 at the LAN1 to the access points AP1, AP2 and AP, it is important to provide an load-balancing scheme to maintain the quality of service (QoS) contacted by each of the terminals and the access points.

In an preferred embodiment of the invention, which provides architecture for quality of service (QoS) based load-balancing scheme in network communication between LAN and WLAN, each of the class of service is mapping to one or more virtual local area networks (VLANs). For accommodating the communication between LAN and WLAN for maintaining the quality of service (QoS), it is configured that one or more service set identifiers (SSIDs) or basic service set identifiers (BSSIDs) in the WLAN are mapping to a VLAN tag in the LAN, according to IEEE 802.1Q. The relationship between SSID or BSSID and the VLAN tag is one-to-one, or many to one. A load balancing module, located in an Ethernet managing center, performs load balancing in according to the corresponding traffic priority class within the same VLAN and one or more SSIDs or BSSIDs between LAN and WLAN.

The service contract specifies the bandwidth dedicated to each subnet (designated by VLAN tag). This of course translates to the assignment of bandwidth available to serve the corresponding queue. The relationship between BSSID and VLAN tag can be either one-to-one or many-to-one, but not one-to-many or many-to-many. That is, one or multiple SSIDs or BSSIDs are mapped to a VLAN tag, but one SSID or one BSSID cannot be mapped to multiple VLAN tags. This implies only one traffic priority type can be defined for each VLAN subnet, no matter the terminals are belonging to the LAN or the WLAN.

The methods of defining the VLAN to which a data packet in the LAN includes (1) a method based on the identity of the port that receives the frame; (2) a method based on the physical address of the terminal that sent the frame (medium access control address of the Ethernet, Token Ring, etc. protocol); and (3) a method based on Internet address (IP), which each data packet contains and constitutes the logical address of the terminal that sent the data packet. In alternative embodiments of the invention to provide architecture for quality of service (QoS) based load-balancing scheme in network communication between LAN and WLAN, the identity of the port, physical address of the terminal including MAC address, Token Ring or etc. protocols, or Internet address (IP) can also be used for the mapping method for the SSIDs or BSSIDs in the WLAN to accommodate the communication between LAN and WLAN for maintaining the quality of service (QoS).

For example, in an embodiment, if the Internet address (IP) is used for defining the VLAN, for accommodating the communication between LAN and WLAN for maintaining the quality of service (QoS), it is configured that one or more service set identifiers (SSIDs) or basic service set identifiers (BSSIDs) in the WLAN are mapping to a specific range of the IP according to IEEE 802.1P. The relationship between SSID or BSSID and the range of the IP is one-to-one, or many to one. A load balancing module, located in an Ethernet managing center, performs load balancing in according to the corresponding traffic priority class within the same VLAN and one or more SSIDs or BSSIDs between LAN and WLAN.

In another embodiment, if the MAC address is used for defining the VLAN, for accommodating the communication between LAN and WLAN for maintaining the quality of service (QoS), it is configured that one or more service set identifiers (SSIDs) or basic service set identifiers (BSSIDs) in the WLAN are mapping to a specific MAC address according to IEEE 802.1P. The relationship between SSID or BSSID and the MAC address is one-to-one, or many to one. In a further embodiment, if the identity of the port is used for defining the VLAN, for accommodating the communication between LAN and WLAN for maintaining the quality of service (QoS), it is configured that one or more service set identifiers (SSIDs) or basic service set identifiers (BSSIDs) in the WLAN are mapping to a specific group of the ports in the switch. The relationship between SSID or BSSID and the specific group of the ports is one-to-one, or many to one.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A quality of service (QoS) based load-balancing scheme in network communication between a local area network (LAN) and a wireless local area network (WLAN), comprising:
a load balancing decision being made by a load balancing module according to traffic conditions and bandwidth availability of each traffic priority class based on a corresponding class of service; and
the load balancing module mapping an identifier in the LAN to one or more identifiers in the WLAN for accommodating the communication between LAN and WLAN for maintaining the quality of service (QoS).

2. The load balancing method as claimed in claim 1, wherein the load balancing module is located in an Ethernet managing center of the LAN.

3. The load balancing method as claimed in claim 1, wherein the load balancing decision being made also by taking into consideration of a plurality of virtual local area networks (VLANs) per VLAN tag basis at the LAN.

4. The load balancing method as claimed in claim 1, wherein each of the VLANs is defined with the corresponding traffic priority class.

5. The load balancing method as claimed in claim 1, wherein each of the class of service being mapping to the plurality of virtual local area networks (VLANs), each of a plurality of identifiers in the WLAN being mapping to a VLAN tag corresponding to one of the LAN.

6. The load balancing method as claimed in claim 5, wherein the relationship between the identifiers in the WLAN and VLAN tag is one-to-one.

7. The load balancing method as claimed in claim 5, wherein the relationship between the identifiers in the WLAN and VLAN tag is many-to-one.

8. The load balancing method as claimed in claim 5, wherein the load balancing module performs load balancing in according to the corresponding traffic priority class within the same VLAN and the same identifier in the WLAN.

9. The load balancing method as claimed in claim 5, wherein the load balancing module performs load balancing in according to the corresponding traffic priority class within the same VLAN and the identifiers in the WLAN.

10. The load balancing method as claimed in claim 5, wherein the identifiers in the WLAN are service set identifiers (SSIDs).

11. The load balancing method as claimed in claim 5, wherein the identifiers in the WLAN are basic service set identifiers (BSSIDs).

12. The load balancing method as claimed in claim 1, wherein the load balancing decision being made also by taking into consideration of a plurality of virtual local area networks (VLANs) per port number of switches at the LAN.

13. The load balancing method as claimed in claim 12, wherein the relationship between the identifiers in the WLAN and a group of the port number of switches is one-to-one.

14. The load balancing method as claimed in claim 12, wherein the relationship between the identifiers in the WLAN and a group of the port number of switches is many-to-one.

15. The load balancing method as claimed in claim 12, wherein the load balancing module performs load balancing in according to the corresponding traffic priority class within the same VLAN and the same identifier in the WLAN.

16. The load balancing method as claimed in claim 12, wherein the load balancing module performs load balancing in according to the corresponding traffic priority class within the same VLAN and the identifiers in the WLAN.

17. The load balancing method as claimed in claim 12, wherein the identifiers in the WLAN are service set identifiers (SSIDs).

18. The load balancing method as claimed in claim 12, wherein the identifiers in the WLAN are basic service set identifiers (BSSIDs).

19. The load balancing method as claimed in claim 1, wherein the load balancing decision being made also by taking into consideration of a plurality of virtual local area networks (VLANs) per Internet address (IP).

20. The load balancing method as claimed in claim 19, wherein the relationship between the identifiers in the WLAN and Internet address (IP) is one-to-one.

21. The load balancing method as claimed in claim 19, wherein the relationship between the identifiers in the WLAN and Internet address (IP) is many-to-one.

22. The load balancing method as claimed in claim 19, wherein the load balancing module performs load balancing in according to the corresponding traffic priority class within the same VLAN and the same identifier in the WLAN.

23. The load balancing method as claimed in claim 19, wherein the load balancing module performs load balancing in according to the corresponding traffic priority class within the same VLAN and the identifiers in the WLAN.

24. The load balancing method as claimed in claim 19, wherein the identifiers in the WLAN are service set identifiers (SSIDs).

25. The load balancing method as claimed in claim 19, wherein the identifiers in the WLAN are basic service set identifiers (BSSIDs).

26. The load balancing method as claimed in claim 1, wherein the load balancing decision being made also by taking into consideration of a plurality of virtual local area networks (VLANs) per medium access control address (MAC).

27. The load balancing method as claimed in claim 26, wherein the relationship between the identifiers in the WLAN and the medium access control address (MAC) is one-to-one.

28. The load balancing method as claimed in claim 26, wherein the relationship between the identifiers in the WLAN and the medium access control address (MAC) is many-to-one.

29. The load balancing method as claimed in claim 26, wherein the load balancing module performs load balancing in according to the corresponding traffic priority class within the same VLAN and the same identifier in the WLAN.

30. The load balancing method as claimed in claim 26, wherein the load balancing module performs load balancing in according to the corresponding traffic priority class within the same VLAN and the identifiers in the WLAN.

31. The load balancing method as claimed in claim 26, wherein the identifiers in the WLAN are service set identifiers (SSIDs).

32. The load balancing method as claimed in claim 26, wherein the identifiers in the WLAN are basic service set identifiers (BSSIDs).
